(19) United States
(12) Patent Application Publication
(10) Pub. No.: US 2011/0269872 A1
(43) Pub. Date: Nov. 3, 2011

(54) PREPARING METHOD OF POLYMER NANO-COMPOSITES

(75) Inventors: Jae-Do Nam, Seoul (KR); Chan-Woo Lee, Suwon (KR); Jong Min Park, Incheon (KR); Wan Sul Lee, Yongin (KR); Seong Hoon Lee, Ulsan (KR)

(73) Assignee: HYUNDAI MOTOR COMPANY, Seoul (KR)

(21) Appl. No.: 12/914,435

(22) Filed: Oct. 28, 2010

(30) Foreign Application Priority Data
Apr. 30, 2010 (KR) 10-2010-0040427

(51) Int. Cl. C08J 3/215; C08K 3/34

(52) U.S. Cl. 523/334; 524/446

(57) ABSTRACT

Provided is a method for preparing a polymer nano-composite, more particularly, an economical method for preparing a polymer nano-composite with improved properties via a single process of organic treatment of a layered clay mineral and dispersion in a rubber latex material at a pH where both the rubber latex material and the layered clay mineral are stabilized. The provided method for preparing a polymer nano-composite allows effective dispersion without using an organic modification process for improving dispersibility of the layered clay mineral in resin. Thus prepared polymer nano-composite exhibits superior mechanical property and may be usefully applied for automobile interior and exterior materials.

### CROSS-REFERENCE TO RELATED APPLICATIONS

This application claims priority under 35 U.S.C. §119 to Korean Patent Application No. 10-2010-0040427, filed on Apr. 30, 2010, the disclosure of which is incorporated herein by reference in its entirety.

### TECHNICAL FIELD

The following disclosure relates to a method for preparing a polymer nano-composite. The disclosed method for preparing a nano-composite enables organic treatment and dispersion of a layered clay mineral filler via a single process.

### BACKGROUND ART

Because of advantages including lightness, design flexibility, molding processability and others, polymer materials are extensively used for industrial materials in the field of automobile, electric and electronic industries as well as for household products. However, since polymer materials generally have unsatisfactory heat resistance, flame retardancy or mechanical property in themselves as compared to metal or ceramic materials, a reinforcing filler such as carbon black, silica, or the like is added.

Recently, various attempts are made to use a layered clay mineral as a filler. A polymer nano-composite including a layered clay mineral is drawing a lot of attentions because, in spite of low inorganic material content as compared to existing composite materials, exhibits better thermal and mechanical properties. However, the layered clay mineral is problematic in that it is not dispersed well in a lipophilic polymer because of its hydrophilic surface. To solve this problem, a process of preparing an organically modified layered clay mineral by inserting an organically modifying agent between the layers of the layered clay mineral. And, in Korean Patent Nos. 10-0872116, 10-0851283 and 10-0458130, polymer nano-composites prepared by dispersing the organically modified layered clay mineral by a melt mixing method whereby a polymer material and an additive are directly added in a Banbury mixer or a roll mixer.

Also, an emulsion mixing method whereby a rubber material in emulsion state, not in solid state, is used, a reinforcing agent is added in solution state, and the resulting mixture is forcibly precipitated to prepare a composite is employed recently. For example, Korean Patent No. 10-0750948 discloses a rubber composition prepared by dispersing an organically modified layered clay mineral by emulsion mixing. The emulsion mixing method provides improved mechanical properties as compared to the melt mixing method, because the additive is uniformly dispersed in the composite.

However, the aforesaid techniques require a pretreatment process of organic treatment in order to disperse the layered clay mineral in the polymer. Further, they are limited in terms of exfoliation of particles, dispersion stability, binding capacity with the polymer material, or the like, since colloidal stability is not considered.

The above information disclosed in this Background Art section is only for enhancement of understanding of the background of the invention and therefore it may contain information that does not form the prior art that is already known in this country to a person of ordinary skill in the art.

### SUMMARY

The inventors of the present invention have made efforts to solve the above problems. As a result, they have found a stable pH range common to a rubber latex material as a polymer source and an organically modified layered clay mineral for emulsion mixing based on the zeta potential theory, developed an economical single process capable of performing organic treatment of the layered clay mineral and the rubber latex at once, and completed the present invention.

Accordingly, an embodiment of the present invention is directed to providing a novel method for preparing a polymer nano-composite capable of effectively dispersing a layered clay mineral in a rubber latex material without a pretreatment process.

In one general aspect, the present invention provides a method for preparing a polymer nano-composite, including: dispersing a layered clay mineral in water and adjusting pH to 6-12 so as to prepare a dispersion; adding a rubber latex material and C₁₂-C₂₂ substituted or unsubstituted alkylammonium to the dispersion and stirring and heating so as to prepare a mixture; adjusting pH of the mixture to 3-4 so as to form a precipitate; and washing the precipitate with ultrapure water and then drying.

The method for preparing a polymer nano-composite according to the present invention provides a better dispersion stability than the existing mixing method since the layered clay mineral is dispersed in a stable pH range common to the rubber latex and the layered clay mineral, which is measured based on the zeta potential. Further, since the organic treatment and dispersion of the layered clay mineral are performed via a single process, a polymer nano-composite with improved physical properties can be prepared economically through a simple process. Thus prepared polymer nano-composite can be useful as automobile interior and exterior materials.

Other features and aspects will be apparent from the following detailed description, the drawings, and the claims.

### BRIEF DESCRIPTION OF THE DRAWINGS

The above and other objects, features and advantages of the present invention will become apparent from the following description of preferred embodiments given in conjunction with the accompanying drawings, in which:

FIG. 1 shows a process of preparing a polymer nano-composite whereby organic treatment and dispersion of a layered clay mineral is integrated; and

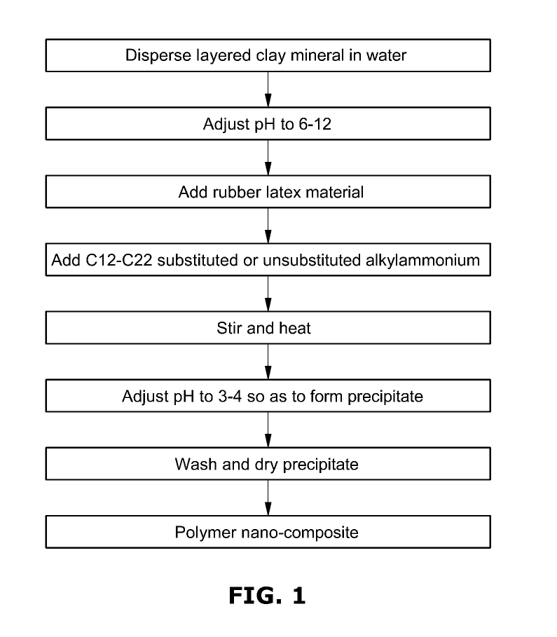

FIG. 2 is a zeta potential graph showing a stable pH range common to a natural rubber latex and a layered clay mineral.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

The present invention relates to a method of preparing a polymer nano-composite by performing organic treatment and dispersion of a layered clay mineral via a single process in a pH range where rubber latex and the layered clay mineral are commonly stabilized.

First, the layered clay mineral is dispersed in water and pH is adjusted to 6-12 so as to prepare a dispersion. The layered clay mineral may be one or more natural or synthetic clay mineral(s) selected from montmorillonite, rectorite, bentonite, hectorite, saponite, sauconite, vermiculite, magadiite, kenyaite, kaolinite and thuringite.

The layered clay mineral has an aspect ratio with larger width than thickness. Preferably, the width to thickness may be 100-10,000. Such shape provides a long, meandering path for gas in the resulting composite and, consequently, improves heat resistance of the composite. The layered clay mineral filler may be used in an amount of 1-30 parts by weight, preferably 3-20 parts by weight based on 100 parts by weight of the rubber latex material. If it is used in an amount less than 1 part by weight, the effect of mechanical reinforcement may decrease. Otherwise, if it is used in an amount exceeding 30 parts by weight, the filler may not disperse well and the mechanical property may be degraded. Hence, the aforesaid range is preferred.

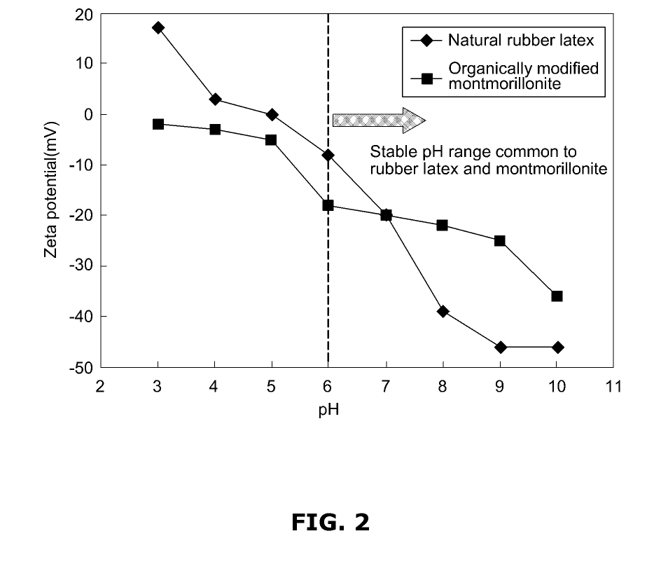

In the present invention, a stable condition common to the rubber latex and the organically modified layered clay mineral is selected based on the zeta potential measurement in colloidal state so as to ensure dispersion stability. In emulsion state, polymer particles are stabilized by electrical repulsion between the particles. The degree of electrical repulsion between the particles is indicated by the zeta potential value. In general, when the absolute value of the zeta potential is 10 or larger, a colloidal dispersion is stable. And, if it approaches 0, the dispersion system is unstable. If the surface polarity is 0, the particles cannot repel each other but coagulate to form an unstable state. In the present invention, zeta potential of the natural rubber latex and an organically modified montmorillonite is measured in colloidal state to find a stable pH range common to the rubber latex material and the organically modified layered clay mineral. In colloidal state, there is no significant difference in the zeta potential values of the rubber latex material and the organically modified layered clay mineral depending on their kinds, a stable pH range of other rubber latex materials and organically modified layered clay minerals may be predicted from the zeta potential values of the natural rubber latex and the organically modified montmorillonite. The result is shown in FIG. 2. As seen from FIG. 2, a stable pH range common to the natural rubber latex and the layered clay mineral montmorillonite, i.e. the pH range where the absolute values of the zeta potential are 10 or larger, is pH 6 or above. Accordingly, pH is adjusted to 6 or above during the preparation of the dispersion. If pH exceeds 12, the apparatus for preparation may corrode by the strongly alkaline solution. Thus, the pH of the dispersion is adjusted to 6-12. The acidity of the dispersion may be controlled using a known alkaline substance such as sodium hydroxide.

Then, a rubber latex material and C₁₂-C₂₂ substituted or unsubstituted alkylammonium are added to the dispersion, which is then stirred and heated to prepare a mixture. Preferably, the rubber material is one having uniform property and superior processability, mechanical strength and, in particular, extension crystallinity so as to provide high strength during crosslinking. Natural rubber (NR) having superior tensile property and fatigue resistance, butadiene rubber (BR) having superior wear resistance, resilience and aging resistance, styrene butadiene rubber (SBR) having superior aging resistance and damping performance, nitrile butadiene rubber having superior oil resistance and damping performance, fluorine rubber (FR) having superior heat resistance and oil resistance, or a combination thereof may be used depending on applications.

The C₁₂-C₂₂ substituted or unsubstituted alkylammonium is used for organic treatment to modify the surface of the layered clay mineral and increase the gap between the layers. Specifically, one or more alkylammonium with a large molecular weight capable of exchanging cations existing between the layers of the clay mineral, e.g. sodium (Na⁺), through cation exchange reaction, such as dodecylamine, tetradecylamine, hexadecylamine, octadecylamine, octadecyltrimethylammonium chloride, or the like, may be used. Preferably, the C₁₂-C₂₂ substituted or unsubstituted alkylammonium is used in an amount of 3-13 parts by weight based on 100 parts by weight of the rubber latex material. If it is used in too small an amount, the layered clay mineral may not disperse well because of insufficient organic treatment. And, if it is used in too large an amount, corrosion of the reactor may occur during the preparation process. The layered clay mineral organically modified by the C₁₂-C₂₂ substituted or unsubstituted alkylammonium is dispersed at pH 6-12, where both the layered clay mineral and the rubber latex material are stable, and then stirred and heated so that a polymer nano-composite is produced through bonding with the rubber molecules. As a result, a mixture is prepared. Preferably, the stirring is performed at 400-800 rpm and the heating is performed 60-80 ° C. If the stirring rate or the heating temperature is too low, dispersibility may decrease. Otherwise, if the stirring rate or the heating temperature is too high, cation exchange reaction between the layers of montmorillonite may not occur well.

Then, the pH of the mixture is adjusted to pH to form a precipitate. During this process, the polymer nano-composite in the mixture is precipitated and extracted at pH 3-4, where both the rubber latex material and the organically modified layered clay mineral are unstable. An acid such as dilute hydrochloric acid, acetic acid, formic acid, or the like may be used. This process is economical in that the polymer nano-composite can be produced by partly modifying the existing rubber preparation process of extracting solid rubber from a rubber latex material.

Then, the precipitate is filtered, washed with ultrapure water, and then dried so as to obtain the polymer nano-composite.

Optionally, thus prepared polymer nano-composite may further comprise an additive such as a crosslinking agent, a crosslinking accelerator, an activator, an antiaging agent, or the like. The polymer nano-composite may be used as a master batch wherein the layered clay mineral is included in large quantity.

The crosslinking agent serves to harden the rubber material and confer mechanical property. A suitable crosslinking agent commonly used in the related art, preferably sulfur, may be used. The crosslinking agent may be used in an amount of 0.3-5 parts by weight based on 100 parts by weight of the rubber material. If the crosslinking agent is used in an amount less than 0.3 part by weight, mechanical strength may be degraded because of decreased crosslinking density. On the other hand, if it is used in an amount exceeding 5 parts by weight, the risk of reversion during crosslinking increases and heat resistance may be degraded. Hence, the aforesaid range is preferred.

The crosslinking accelerator may be one commonly used in the art without limitation. For instance, one or more selected from N-cyclohexyl-2-benzothiazole sulfenamide (CBS/CZ), dibenzothiazyl disulfide (DBTD/DM) and tetramethylthiuram disulfide (TMTD/TT) may be used. The crosslinking accelerator may be used in an amount of 0.5-5 parts by weight based on 100 parts by weight of the rubber material. If the crosslinking accelerator is used in an amount less than 0.5 part by weight, multisulfur crosslinking may not be accomplished because an effective crosslinking system is not formed. Meanwhile, if it is used in an amount exceeding 5 parts by weight, scorching may occur. Hence, the aforesaid range is preferred.

The activator serves to activate the crosslinking accelerator, and one commonly used in the related art may be used without limitation. Preferably, stearic acid, zinc oxide or a mixture thereof may be used. Preferably, the activator may be used in an amount of 2-10 parts by weight based on 100 parts by weight of the rubber material. If the activator is used in an amount less than 2 parts by weight, the crosslinking occurs slowly. If, on the other hand, it is used in an amount exceeding 10 parts by weight, the crosslinking occurs too quickly. Hence, the aforesaid range is preferred.

Of the additives, the antiaging agent is used to improve fatigue resistance and ozone resistance of the rubber. One or more selected from an amine-based antiaging agent, a phenol-based antiaging agent and a polyimide-based antiaging agent may be used. Preferably, one or more selected from N-phenyl-N′-isopropyl-p-phenylenediamine (IPPD/810-NA), N-phenyl-N′-(1,3-dimethylbutyl)-p-phenylenediamine (6PPD), 2,2,4-trimethyl-1,2-dihydroquinoline (TMQ/RD), 2-mercaptobenzimidazole (MBI/MB), zinc benzimidazole-2-sulfanate (ZMBI/MBZ) and aliphatic hydrocarbon wax may be used. Use of a combination thereof may improve heat resistance of the rubber elastomer through a synergic effect. The antiaging agent may be used in an amount of 1-15 parts by weight based on 100 parts by weight of the rubber material. If the antiaging agent is used in an amount less than 1 part by weight, the aging of the rubber may not be prevented. Meanwhile, if it is used in an amount exceeding 15 parts by weight, it is difficult to accomplish uniform dispersion in the rubber mixture and mechanical property may be degraded. Hence, the aforesaid range is preferred.

The method for preparing a polymer nano-composite according to the present invention provides better dispersion stability as compared to the existing mixing method because the layered clay mineral is dispersed at a pH where both the rubber latex and the layered clay mineral are stabilized. Further, a polymer nano-composite with improved physical properties may be obtained simply and economically since organic treatment and dispersion of the layered clay mineral are performed by a single process.

### EXAMPLES

The examples and experiments will now be described. The following examples and experiments are for illustrative purposes only and not intended to limit the scope of this disclosure.

### Example 1

5 parts by weight of montmorillonite, a layered clay mineral, was added to water (200 mL) based on 100 parts by weight of a natural rubber latex. After dispersing using a mixer, sodium hydroxide was added to adjust pH to 10.5. To the resulting dispersion, 100 parts by weight of the natural rubber latex was added. Then, after adding 3 parts by weight of dodecylamine based on 100 parts by weight of the natural rubber latex, the mixture was stirred for 60 minutes at 400 rpm while heating at 80° C. To the resulting mixture, a mixture solution of hydrochloric acid (20 mL) and water (400 mL) was added to precipitate a polymer nano-composite in the mixture. The precipitated polymer nano-composite was filtered, washed with ultrapure water, and dried at 80° C. for 24 hours. The dried polymer nano-composite was recovered and then dispersed after mixing with a crosslinking agent, a crosslinking accelerator, an activator and an antiaging agent using a roll mixer. A polymer nano-composite elastomer wherein 5 parts by weight of montmorillonite is dispersed based on 100 parts by weight of the natural rubber was prepared by processing at 80° C. Details are given in Table 1.

### Example 2

20 parts by weight of montmorillonite, a layered clay mineral, was added to water (200 mL) based on 100 parts by weight of a natural rubber latex. After dispersing using a mixer, sodium hydroxide was added to adjust pH to 10.5. To the resulting dispersion, 100 parts by weight of the natural rubber latex was added. Then, after adding 12 parts by weight of dodecylamine based on 100 parts by weight of the natural rubber latex, the mixture was stirred and heated as in Example 1. To the resulting mixture, a mixture solution of hydrochloric acid (20 mL) and water (400 mL) was added to precipitate a polymer nano-composite in the mixture. The precipitated polymer nano-composite was filtered, washed with ultrapure water, and dried at 80° C. for 24 hours. The dried polymer nano-composite was recovered and, after further adding 300 parts by weight of a solid rubber material based on 100 parts by weight of the natural rubber latex, dispersed after mixing with a crosslinking agent, a crosslinking accelerator, an activator and an antiaging agent using a roll mixer. A polymer nano-composite elastomer wherein 5 parts by weight of montmorillonite is dispersed based on 100 parts by weight of the natural rubber was prepared by processing at 80° C.

### Comparative Example 1

An inorganic montmorillonite composite was prepared according to the known melt mixing method. After mechanically dispersing 5 parts by weight of inorganic montmorillonite based on 100 parts by weight of a natural rubber using a roll mixer, a crosslinking agent, a crosslinking accelerator, an activator and an antiaging agent were further mixed and dispersed. A polymer nano-composite elastomer wherein 5 parts by weight of montmorillonite is dispersed was prepared by processing at 80° C.

### Comparative Example 2

An organic montmorillonite composite was prepared according to the known melt mixing method. After mechanically dispersing 5 parts by weight of organically modified montmorillonite based on 100 parts by weight of a natural rubber using a roll mixer, a crosslinking agent, a crosslinking accelerator, an activator and an antiaging agent were further mixed and dispersed. A polymer nano-composite elastomer wherein 5 parts by weight of montmorillonite is dispersed was prepared by processing at 80° C.

### Comparative Example 3

A polymer nano-composite elastomer as in Example 1, except that the pH of the dispersion was not adjusted and dodecylamine was not added.

TABLE 1

| | | Ex. | Ex. | Comp. | Comp. | Comp. |
|---|---|---|---|---|---|---|
| Unit: parts by weight | | 1 | 2 | Ex. 1 | Ex. 2 | Ex. 3 |
| Rubber material | Natural rubber | 100 | 100 | — | — | 100 |
| | latex | | | | | |
| | Solid natural | — | 300 | 100 | 100 | — |
| | rubber | | | | | |
| Clay mineral | Organically | — | — | — | 5 | — |
| | modified | | | | | |
| | montmorillonite | | | | | |
| | Inorganic | 5 | 20 | 5 | — | 5 |
| | montmorillonite | | | | | |
| Alkylammonium | Dodecylamine | 3 | 12 | — | — | — |
| Crosslinking | Sulfur | 1 | 4 | 1 | 1 | 1 |
| agent | | | | | | |
| Crosslinking | N-Cyclohexyl-2- | 2 | 8 | 2 | 2 | 2 |
| accelerator | benzothiazole | | | | | |
| | sulfenamide | | | | | |
| Activator | Zinc oxide | 4 | 16 | 4 | 4 | 4 |
| | Stearic acid | 4 | 16 | 4 | 4 | 4 |
| Antiaging agent | 2,2,4-Trimethy1- | 3 | 12 | 3 | 3 | 3 |
| | 1,2- | | | | | |
| | dihydroquinoline | | | | | |

Natural rubber latex: Natural Rubber Latex (Srijaroen Latex Co., Thailand)
Solid natural rubber: SMR-CV60
Organic montmorillonite: CLOISITE 25A (Southern Clay Products, INC.)
Inorganic montmorillonite: CLOISITE Na+ (Southern Clay Products, INC.)

Physical Property Test

1) Exfoliation of Layered Clay Mineral

X-ray diffraction (XRD) analysis was performed using an XRD-6000 diffractometer in order to evaluate the degree of exfoliation of the clay mineral from the polymer nano-composites prepared in Examples 1-2 and Comparative Examples 1-3. Distance between the layers of montmorillonite was calculated from the 20 value. The result is given in Table 2.

2) Hardness, Tensile Strength and Tear Strength

Hardness, tensile strength and tear strength of the polymer nano-composites prepared in Examples 1-2 and Comparative Examples 1-3 were measured according to KS M 6784 and KS M 6782. The result is given in Table 2.

TABLE 2

| | | | | Comp. | Comp. | Comp. |
|---|---|---|---|---|---|---|
| | | Ex. 1 | Ex. 2 | Ex. 1 | Ex. 2 | Ex. 3 |
| XRD | Interlayer | >4 | >4 | 1.5 | 1.7 | 1.6 |
| analysis | distance (nm) | | | | | |
| Physical | Hardness (Hs) | 47 | 45 | 39 | 42 | 42 |
| properties | Tensile strength | 27 | 24 | 17 | 19 | 21 |
| | (MPa) | | | | | |
| | Tear strength | 50 | 40 | 29 | 34 | 36 |
| | (kg/cm) | | | | | |

As seen from Table 2, the XRD analysis result revealed that the interlayer distance of the polymer nano-composites prepared by organic treatment and emulsion dispersing in Examples 1-2 according to the present invention was more than 2 times that of those prepared by melt mixing in Comparative Example 1-2. This indicates that the filler, i.e. the layered clay mineral, was effectively exfoliated and dispersed. Comparative Example 3, wherein emulsion dispersing was employed but neither the pH of the dispersion was adjusted nor dodecylamine was added, showed little difference in the interlayer distance from the melt mixing. It can be seen that the polymer nano-composites prepared in Examples 1-2, wherein the filler is exfoliated and dispersed well, shows superior mechanical properties such as hardness, tensile strength and tear strength.

To conclude, the method for preparing a polymer nano-composite of the present invention enables preparation of polymer nano-composites having superior mechanical property by inducing effective exfoliation and dispersion of the filler, i.e. the layered clay mineral. Thus prepared nano-composite can be usefully applied for automobile interior and exterior materials.

While the present invention has been described with respect to the specific embodiments, it will be apparent to those skilled in the art that various changes and modifications may be made without departing from the spirit and scope of the invention as defined in the following claims.

What is claimed is:

1. A method for preparing a polymer nano-composite, comprising:
dispersing a layered clay mineral in water and adjusting pH to 6-12 so as to prepare a dispersion;
adding a rubber latex material and C₁₂-C₂₂ substituted or unsubstituted alkylammonium to the dispersion and stirring and heating so as to prepare a mixture;
adjusting pH of the mixture to 3-4 so as to form a precipitate; and
washing the precipitate with ultrapure water and then drying.

2. The method for preparing a polymer nano-composite according to claim 1, wherein the layered clay mineral is one or more selected from montmorillonite, rectorite, bentonite, hectorite, saponite, sauconite, vermiculite, magadiite, kenyaite, kaolinite and thuringite.

3. The method for preparing a polymer nano-composite according to claim 1, wherein the rubber material is one or more selected from natural rubber (NR), butadiene rubber (BR), styrene butadiene rubber (SBR), nitrile butadiene rubber and fluorine rubber (FR).

4. The method for preparing a polymer nano-composite according to claim 1, wherein the C₁₂-C₂₂ substituted or unsubstituted alkylammonium is one or more selected from dodecylamine, tetradecylamine, hexadecylamine, octadecylamine and octadecyltrimethylammonium chloride.

5. The method for preparing a polymer nano-composite according to claim 1, wherein the layered clay mineral is used in an amount of 1-30 parts by weight based on 100 parts by weight of the rubber latex material.

6. A polymer nano-composite prepared by the method according to claim 1.
